(19) United States
(12) Patent Application Publication
(10) Pub. No.: US 2006/0253840 A1
(43) Pub. Date: Nov. 9, 2006

(54) Program verification and visualization using a dynamic abstracted conceptual model

(75) Inventors: Gordon Cruickshank, West Lothian (GB); Alan West, Edinburgh (GB)

Correspondence Address: EDWARDS & ANGELL, LLP, P.O. BOX 55874, BOSTON, MA, 02205, US

(73) Assignee: eoLogic Limited, West Lothian (GB)

(21) Appl. No.: 11/408,673

(22) Filed: Apr. 21, 2006

Related U.S. Application Data
(60) Provisional application No. 60/675,238, filed on Apr. 27, 2005.

(30) Foreign Application Priority Data
Apr. 25, 2005 (GB) 0508270.6

(51) Int. Cl. G06F 9/44

(52) U.S. Cl. 717/127

(57) ABSTRACT

A system and method for software development and in particular runtime program verification. The system is capable of monitoring a computer program and maintaining an abstracted model of the computer program using an agent which monitors a plurality of execution points in the program during the running of the computer program. The abstract model of the computer program is updated upon execution of the computer program at at least one of the execution points. The agent may also be adapted to detect a pattern in the abstracted model and issue an alert upon detection of the pattern.

### CROSS-REFERENCE TO RELATED APPLICATION

This application is claims the benefit of British Patent Application No. 0508270.6 filed in English on Apr. 25, 2005 and U.S. Patent Application No. 60/675,238 filed on Apr. 27, 2005, the disclosure of which applications are incorporated herein in their entireties by this reference.

### BACKGROUND OF THE INVENTION

1. Field of the Invention

The present invention relates to software development and in particular runtime program verification.

2. Background of the Related Art

Computer programs are becoming increasingly large and complex as application programmers adopt standard frameworks for application construction. Typically, the code a programmer writes forms only a small part of the overall application functionality. Correspondingly, the extent to which code uses the services provided by the framework has become critical to the overall performance in the operation of the system. Frequently, however, the framework is used inefficiently or incorrectly.

Enterprise software includes much commercial software such as sophisticated financial systems, popular websites and large scale management and administration systems. Modern enterprise software systems are generally based on standardised multi user application server software, for which there are currently two main frameworks: the Java-based J2EE (Java 2 platform, Enterprise Edition) framework and the Microsoft's .NET framework. Both aim to reduce cost and development time for large scale software development. However, developers have considerable difficulty programming and testing software using these frameworks.

The problem with application servers is their complexity. They comprise a diverse, very extensive range of sophisticated interacting components which programmers must understand fully to produce optimal systems.

Due to the complexity of the environment, developers frequently make mistakes in assembling the components and services that comprise an application. Many developers make the same mistakes for recurring reasons. For example, trying to take short cuts, not appreciating the performance penalties of some of their choices, not being up to date with the latest facilities and being unaware of interactions between services they select to use.

As application servers implement standard sets of services with standard interfaces, many of these bad practices can be described systematically. Popular programming text books have identified key antipatterns. An antipattern is a repeated application of code or design that leads to a bad outcome. The outcome can be poor performance, hard to maintain code or even a complete failure of the project.

Systems are known that are able to detect some antipatterns statically by analysing source code, however many problematic patterns of use only arise dynamically as the software executes. Although some systems have been described that dynamically detect problems such as faulty thread interactions and memory usage problems, which can be classed as language level antipatterns, no system is known to be able to generally detect higher level dynamic antipatterns described in terms of the interfaces of a complex object-orientated framework.

In Aspect Oriented Programming (AOP), sequences of supporting code can be executed whenever certain conditions in the main program are satisfied whenever certain methods are called or returned etc. This is used to implement such functionality as tracing and transaction control. AOP may be implemented using JVMDI (Java Virtual Machine Debug Interface), or more usually byte code modification. However, AOP does not provide a way for dynamically determining automatically the presence of poor programming practices.

Known J2EE performance monitoring systems aim to identify performance related problems in executing J2EE applications servers. They typically have two modes of operation: resource monitoring and transaction monitoring. In the former mode they record different items of statistical information over a specified execution period. If the rolling value of any of the metrics exceeds normal ranges then the system signals that there is a problem. In the latter mode the monitoring system checks application-level transactions within an application server by following transaction IDs and linking message IDs. The system times the parts of the transaction to determine the overall time taken. However, both types of J2EE performance monitoring systems are not able to detect antipatterns in the actual structure of the running application server; instead they are concerned with summary numbers which indicate how well the application server is performing.

Post mortem tracing tools are known, aimed at supporting the subsequent analysis of failures in deployed application servers. They do not provide any integrated structural checking although they can store metric-based detection of problems (i.e. statistical limits being exceeded, similar to the J2EE performance monitoring systems). These tools can trace various levels of calls made in an application server and also record some performance metrics. However they do not evaluate the quality of construction of the applications. Instead they store and trace performance information for subsequent off-line evaluation.

Static antipattern detectors, such as IBM's™ Structural Analysis for Java software, analyse source code and are able to draw graphs showing inter dependencies between source code elements. They can detect some patterns of dependency which indicate poor construction. However these are static elements of program constructions, rather than for example, Java runtime objects. Therefore, they are not capable of detecting the runtime antipatterns of use and structure.

U.S. Pat. No. 6,792,460 entitled “System and Methods for Monitoring Application Server Performance” describes a method of monitoring application servers for determining performance. However its objective is to track only the start and stop times for performance monitoring.

### SUMMARY OF THE INVENTION

It is an object of an aspect of the present invention to maintain an abstracted model of a running computer program.

According to a first aspect of the present invention there is provided a system for monitoring a computer program and maintaining an abstracted model of the computer program, the system comprising an agent adapted to set a plurality of execution points in the program, to monitor the execution points during the running of the computer program and upon execution of the computer program at at least one of the execution points, to update the abstracted model of the computer program.

Preferably, the agent is further adapted to detect a pattern in the abstracted model and issue an alert upon detection of the pattern.

Preferably, the agent is adapted to detect the pattern upon update of the abstracted model.

Preferably, the system further comprises a model definition module adapted to store the definition of the abstracted model of the computer program and the agent is further adapted to update the abstracted model using the stored definition.

Preferably, the system further comprises a client module adapted to cause the display of the abstracted model.

Preferably, the system further comprises a program-level model and the agent is further adapted to update the program-level model upon execution of the computer program at the at least one of the execution points.

Preferably the program-level model comprises a static component containing class and method level information and a dynamic component containing method call and object level information, the agent being further adapted to update the dynamic component of the program-level model upon execution of the computer program at the at least one of the execution points.

Preferably, the abstracted model is adapted to store one or more entities representing individual program objects or selected parts of several program objects or the presence of any one of several program objects or part of a program object and to store relationships between the entities.

Preferably each entity corresponds to an individual program object or selected parts of several program objects or the presence of any one of several program objects or a part of a program object.

According to a second aspect of the present invention there is provided a method for monitoring a computer program, the method comprising the steps of:
setting a plurality of execution points in the program;
creating an abstracted model of the program;
monitoring the execution points during running of the program; and
upon execution of the program at at least one of the execution points updating the abstracted model of the program.

Preferably, the method further comprises the steps of detecting a pattern in the abstracted model and issuing an alert upon detection of a pattern.

Preferably, the step of detecting the pattern is performed upon update of the abstracted model.

Preferably, the method further comprises the step of storing the definition of an abstracted model of the program and the step of updating the abstracted model is dependent on the stored definition.

Preferably, the method further comprises the step of displaying the abstracted model.

Preferably, the step of updating the abstracted model comprises storing or destroying one or more entities and relationships between the entities.

Preferably each entity corresponds to an individual program object or selected parts of several program objects or the presence of any one of several program objects or a part of a program object.

According to a third aspect of the present invention there is provided a second computer program comprising program instructions for causing a computer to perform the method according to the second aspect.

Preferably said second computer program is embodied on a recording medium or read-only memory, stored in at least one computer memory, or carried on an electrical carrier signal.

It should be appreciated that the present invention can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

An embodiment of the present invention will now be described by way of example only with reference to the following figures, in which:

FIG. 1 illustrates in schematic form a system according to an embodiment of the present invention;

FIG. 2 illustrates a flow chart of the operation of an embodiment of the present invention;

FIG. 3 illustrates a flow chart of processing a program event;

FIG. 4 illustrates a flow chart of entity creation;

FIG. 5 illustrates a flow chart of entity deletion;

FIG. 6 illustrates a flow chart of relationship creation;

FIG. 7 illustrates a flow chart of relationship deletion;

FIG. 8 illustrates a flow chart of alert evaluation; and

FIG. 9 illustrates a screen shot of the display by the visualisation client.

### DETAILED DESCRIPTION OF PREFERRED EMBODIMENTS

The present invention overcomes many of the prior art problems associated with runtime program verification. The advantages, and other features of the systems and methods disclosed herein, will become more readily apparent to those having ordinary skill in the art from the following detailed description of certain preferred embodiments taken in conjunction with the drawings which set forth representative embodiments of the present invention.

One embodiment of the present invention is based on an internal abstract model of the application server that is automatically derived and maintained while monitoring execution of the application server. The embodiment provides a real time conceptual visualisation of the framework and application and indicates exactly where any problems occur with respect to antipatterns and further indicates suggested code re-factorings to improve the situation.

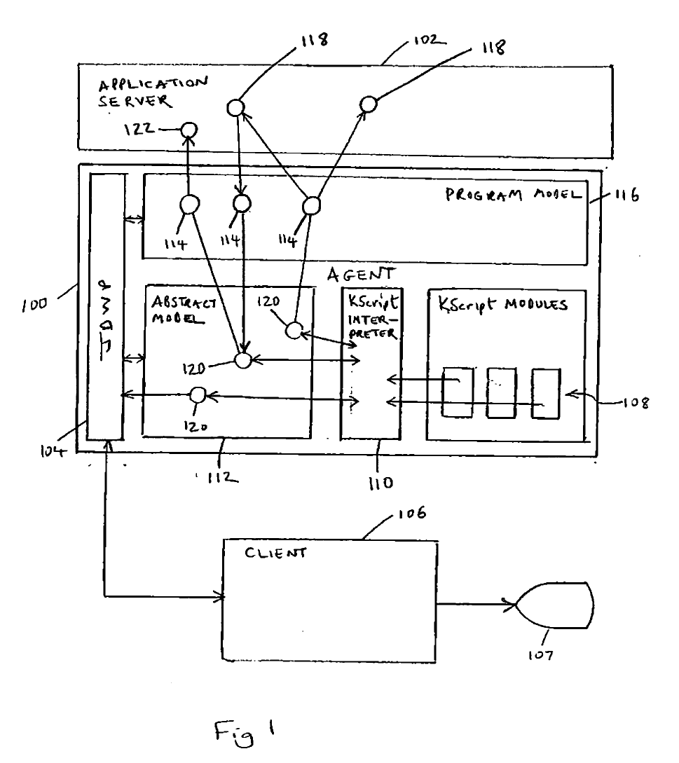

FIG. 1 illustrates the architecture of an embodiment of the present invention. An agent component 100 is used to monitor a Java Virtual Machine (JVM) 102 on which an application server is executing. The agent comprises a software library that is loaded as part of an operating system process, which monitors the operation of the remainder of the process.

Although in this embodiment the implementation is for the Java Virtual Machine, one skilled in the art would be aware that the same technique could equally be applied to the .NET environment and it's Common Language Runtime. Thus the agent forms part of the application process (loaded as a Dynamically Linked Library) and talks to the JVM running the application. It communicates using JDWP (Java Debug Wire Protocol) 104 with a visualization client 106 that drives a visual display 107. The behaviour the agent is driven by the set of KScript modules 108 that the agent reads in when it starts up.

Similarly the behaviour the client is driven by the set of KScript modules that it reads in when it starts up. The agent has a KScript interpreter 110 that interprets the KScript so as to update the abstracted model 112 using the classes and methods 114 of the program model 116 to set multiple points of execution 118 in the application server 102. By monitoring multiple selected points of execution in the application the agent produces a stream of events at the program level. For example object creation/deletion, method call/return, and member variable read/write.

Each event is abstracted into the conceptual level by further processing in a scripting language (referred to as KScript) within the agent. KScript statements in this embodiment are where program level access, model definition and generation, and antipattern rule definition matching and filing are combined. The creation or the change of state of any one of several program objects may trigger the agent to create an abstract entity 120 in the abstract model 112. Similarly method calls are monitored by the agent across several program objects in order to track state and relationship changes within the abstract model and any one of several method calls may cause an identical change in the abstract model. Thus the abstract entities coalesce behaviour from several program objects. In the creation of an Entity, the agent may access further data 122 from the application, in addition to the arguments with types and values passed to it from the application via the program model.

The program model 116 is defined in the KScript language that combines elements at both the program and abstracted conceptual level. In particular:
specification of selective program monitoring points;
access to all aspects of the current program state and ability to record aspects of the program state;
construction of abstract entities and relationships to form an Entity Relationship Attribute (ERA) abstract model of the monitored program;
execution of interspersed Java-like code sequences (referred to in this embodiment as Kj) which may access both the abstracted conceptual level entities and program-level objects to determine when relationships and entities should be created and deleted; and
rules for representing antipatterns which fire when certain entity relationship patterns are formed.

The rules themselves are generally represented using language which is an extension of the EJB-QL (Enterprise Java Bean-Query Language) used for J2EE entity beans, but rules may also be implemented directly in Kj.

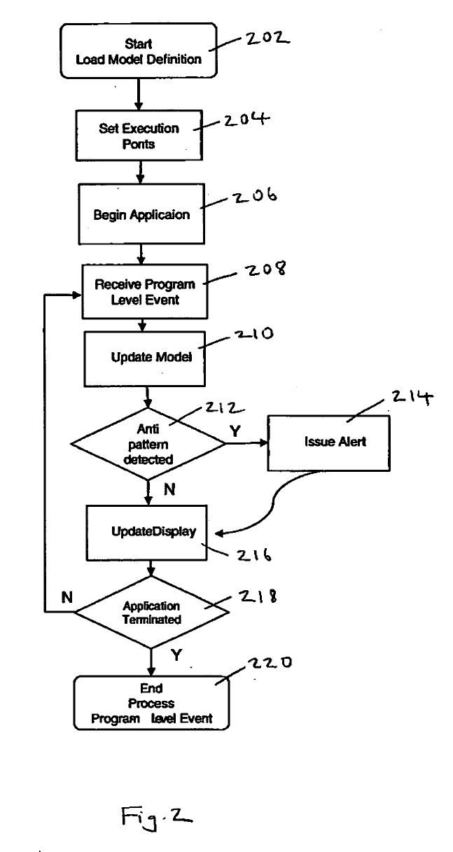

FIG. 2 shows a flowchart of the operation of an embodiment of the method for monitoring a computer program according to the present invention.

With reference to FIG. 2, the method includes the agent loading the definition of an abstracted model 202 of the application server in the KScript module, thereby creating an abstracted model of the application server using the declaration in the KScript module.

The agent sets execution points 204 in the application server using the KScript declarations.

The Application server begins execution 206 and the agent monitors the execution points during running of the program.

Upon execution of the program at the execution points the agent receives a program level event 208 and updates the abstracted model 210. To do this the agent maintains the program-level model. The agent stores entities representing program objects and relationships between the entities. Each entity may in general correspond to selected parts of several program objects or it may correspond selected parts of any one of several program objects (or selected parts of any program objects, or several parts of several program objects).

When the agent detects 212 a pattern in the abstracted model, it issues 214 an alert. The client displays 216 the abstracted model and alerts. If the application is terminated 218, the process ends 220, otherwise the agent receives 208 the next program level event.

In contrast to prior art program level antipattern detectors, this embodiment of the present invention detects higher level patterns relating to how a software framework is used and depends on the services and interfaces provided by the framework.

Rather than coding specific detectors this embodiment of the present invention creates an abstracted conceptual level model of the executing program in the context of the application server and then describes antipattern patterns rules in terms of this model. The model also allows data explaining entities, relationships and antipattern states to be held.

When one looks in detail at the construction of an application server it can be seen that apparently simple interface level concepts like “JMS Connection” do not map internally to instances of a single Java class: several interacting classes are used to implement the concept. This is generally true for conceptual interface types.

The JMS implementation in an application may utilize several hundred Java objects. In contrast this embodiment of the present invention would typically model that with ten to twenty conceptual objects.

The conceptual gearing that this represents allows fault detection rules to be expressed succinctly and portably (independent of implementation details). It also provides a natural basis for a clearly understandable visualization of server state allowing faults to be explained simply and providing the correct level of structure to illustrate refactoring suggestions. A refactoring is a disciplined means of transforming the implementation of code to make the design better without changing the externally visible behaviour.

The term “model” is used frequently above. Specifically in this embodiment of the present invention the term indicates an Entity Relationship Attribute (ERA) model, a well-known form of data model. Conceptual items are Entities and there are pre-specified possible Relationships between these. Relationships can be of arbitrary order (may involve 2 or more entities) and both Entities and Relationships may have Attributes (named integer, Boolean or String values attached to the Entity or Relationship).

For the J2EE framework the concepts employed are related to the component level view of an application server. Typical example concepts would include:
Session Enterprise Java Bean
Entity Enterprise Java Bean
EJB Container
Servlet
JMS Destination
Thread
Transaction
JMS Message
JMS Session
JMS Connection

One skilled in the art would appreciate that there are numerous other possibilities.

Although the specific implementation of this embodiment of the present invention represents antipatterns by an arrangement of software entities, relationships and attributes, there are other equivalent forms of data modelling which would also serve the same purpose; the relational model for example.

In this embodiment, the agent detects a pattern, identifying a pattern against an overall Entity Relationship Attribute model, by executing a query against the model. These queries are executed only when specific contributions to the model which affect the validity of the query are made. If the query result is not empty then alerts signalling the satisfaction of the rule are sent to any attached client.

KScript Modules

The KScript modules provide the full set of information needed to drive the operation of the agent. The client and agent communicate by writing changes to the KScript module files. An advantage is the ease of combining full access to program level information with the ability to construct a high level abstract model conforming to standard database form.

In a similar way to that in which a Java program is composed of classes which service templates for the actual objects (instances of those classes) created at runtime, so the KScript is composed primarily of definitions of alert types, entity types and relationship types which serve as the templates for alerts, entities and relationships respectively created at runtime.

Informally a KScript module has the structure as follows:

```
Alert Definitions
  Alert Definition
  Alert Definition
Relationship Definitions
  Relationship Definition
  Relationship Definition
EntityType Definition
  Entity Trigger Definitions
  Entity Creation task definition
  Entity Destruction task definition
Other Task Definitions
    <selection from below>
    Relationship Creation Tasks
    Relationship Destruction Task
    JK Tasks
    Trigger Enablement Tasks
EntityType Definition
  Entity Trigger Definitions
  Entity Creation task definition
  Entity Destruction task definition
Other Task Definitions
    <selection from below>
    Relationship Creation Tasks
    Relationship Destruction Task
    JK Tasks
    Trigger Enablement Tasks
```

Below is included part of a KScript for creating a model of JTA (Java Transaction API) transaction processing within an application server.

```
<relationships name=“jtaRelationships”>
  <relationship name=“TransactionManagerHasTransaction”/>
  <relationship name=“TransactionManagerHasResource”/>
  <relationship name=“TransactionHasTransactionResource”/>
  <relationship name=“ResourceHasTransactionResource”/>
  <relationship name=“TransactionResourceHasEntry”/>
  <relationship name=“TranEntrySendHasMessage”/>
</relationships>
<entityType visibility=“external” name=“jtaTransaction” events=“true”
debug=“true”>
  <triggers>
    <triggerCreation name=“CreatedT” enabled=“true”/>
    <triggerDestruction name=“DeletedT” enabled=“true”/>
    <triggerCall
        name=“ServerTransactionT”
  class=“Lweblogic/transaction/internal/ServerTransactionImpl;”
        method=“&lt;init&gt;”
        signature=“(Ljavax/transaction/xa/Xid;II)V”
  />
    <triggerCall
        name=“transactionCommitT”
  class=“Lweblogic/transaction/internal/ServerTransactionImpl;”
        method=“commit”
        signature=“( )V”
        entityID=“%{arg0};”
  />
    <triggerReturn
        name=“enlistResourceT”
  class=“Lweblogic/transaction/internal/ServerTransactionImpl;”
        method=“enlistResource”
        signature=“(Ljavax/transaction/xa/XAResource;)Z”
        entityID=“%{arg0};”
  />
  <triggerCall
        name=“setActiveThreadT”
  class=“Lweblogic/transaction/internal/TransactionImpl;”
        method=“setActiveThread”
        signature=“(Ljava/lang/Thread;)V”
        entityID=“%{arg0};”
  />
  </triggers>
  <tasks>
<createEntity name=“createJTATransaction” dcc=“jtaTransaction”
            if=“ServerTransactionT”
key=“%{arg0};”>
  <symbols>
  <member name=“thisObj” type=“object” value=“%{arg0};”/>
  <member name=“xid” type=“object” value=“%{arg1};”/>
<member name=“session” type=“object” value=“null;”/>
  <member name=“tranEntryList” type=“object” value=“new
com.eologic.modelsupport.EOSet( );”/>
      </symbols>
</createEntity>
<createRelationship name=“addDestinationMessageR”
            from=“%{inst};”
            to=“$DCC{%{arg1}};”
            if=“TMAddTransactionT”
/>
```

As can be seen, KScript uses XML to provide its underlying structure. The above fragment shows:
the declaration if the relationships for the JTA Entity Types; and
the declaration of an EntityType (jtaTransaction) including:
   the declaration of a set of triggers which provide the event stream to drive it;
   an entity creation task createJTATransaction is shown which reacts to a trigger to create the entity and initializes some member symbols; and
   another task addDestinationMessageR which responds to a trigger by creating a relationship.

The exact syntax of KScripts may be varied. In this embodiment of the present invention, the syntax combines conceptual-level Entities, Relationships, Attributes and program-level triggers with easy access to full program state. Other syntaxes could be devised to have similar capabilities.

One of the antipatterns the system can detect is when JTA and JMS-based transactions are combined in the use of the same JMS Queue. When both these transaction modes are inadvertently combined it is almost always an error and will probably lead to one of the transactions not being committed. A task that fires a mixed transaction alert is shown below:

```
<method name=“checkForMixedTransactions”
if=“beXAResourceAddTranEntryT”>
<![CDATA[
{
Entity thisTransactionEntry = $Entity{%{arg1}};
  queryResult = $executeQuery(
      “select Entity(t1,t2) from jtaTransaction t1,t2” +
      “where t1.hasResource == ?1 AND t2.hasResource == ?1 ” +
      “AND (t1.hasSession == null AND t2.hasSession !=
null)”,
        new Object[ ] {%{inst}});
  if (!queryResult.isEmpty( ))
  {
  // fire the alert
    Entity jtaTransaction = queryResult.get(0);
    Entity jmsTransaction = queryResult.get(0);
    $createAlert(“mixedTransactions”,
“transacted session”,
  jmsTransaction.getRelatedEntity(“hasSession”,“To”),
      “jta transaction”, jtaTransaction,
      “jms transaction”, jmsTransaction);
  }
}
]]>
</method>
```

Each time a transaction entry is added to a JMS resource (e.g. a message is added to a JMS Destination) the set of transactions for that resource is checked in case there is a transaction with a directly related session and another that has not. If a transaction has a directly related session it is a JMS transaction, controlled by the session object. If it does not it is an ordinary JTA transaction and mixing these usually leads to errors, as the JMS transaction will not be recognized when committing the JTA transaction.

This embodiment of the present invention monitors selected points in program operation. This is done using the JVMDI java debugging interface to insert watchpoints and breakpoints at method calls and returns and member variable modifications. In future versions of Java the new JVMTI interface could be used.

Alternative embodiments of the present invention may also use other methods of monitoring java programs, for example dynamic byte code modification. Byte code modification is a technique by which the Java byte code (the actual executable bytes of the program) are modified as Java classes are loaded to add extra functionality, such as calling a monitor when a method is called or returns or a member variable is changed. The advantage of the byte code technique is likely to be higher throughput of program-level events. However the JVMDI technique has the advantage over byte code modification that it allows this embodiment of the present invention to support debugging functionality as it executes. The agent provides full support of the JDWP wire debugging protocol used by the standard JDI client-side debugging interface.

This embodiment of the present invention has a well-defined interface which separates the use of the technique for obtaining low-level information from the remainder of the program.

In order to service the needs of the KScript the underlying agent must maintain a model of all program-level classes, methods and members to be accessed.

The description below and associated figures cover the typical operating sequences of this embodiment of the present invention.

Program-Level Events Occurrence

When the application server starts the agent reads the KScripts and determines the set of program level monitoring points to install. It then allows the server to continue execution.

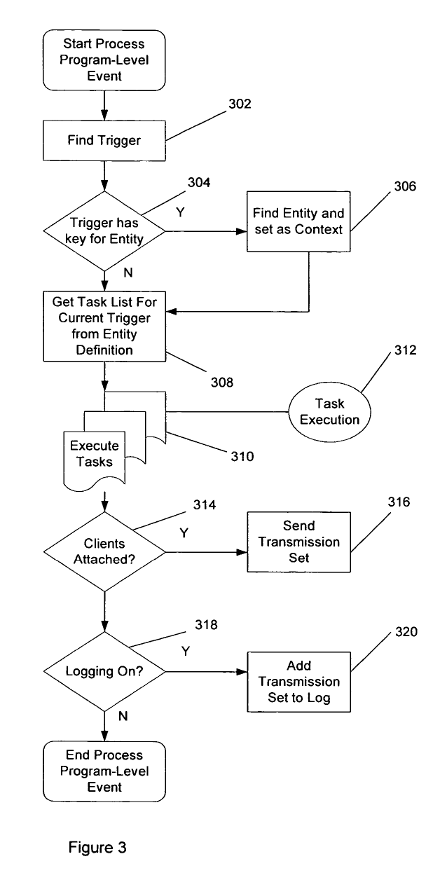

As is shown in FIG. 3, when the agent receives a program-level event from a monitored point in the program it finds 302 any KScript EntityTypes which have registered Triggers for those events. It then finds 304 if a key has been set up which links the program-level event to a particular Entity (e.g. if the current Java Object is a key to an Entity). If it is, it sets the Entity 306 as the current context for execution. It then gets the task list for the current trigger from the entity definition 308 and executes 310, 312 all tasks linked to that Trigger. The order of execution of the tasks is the order they appear in the KScript.

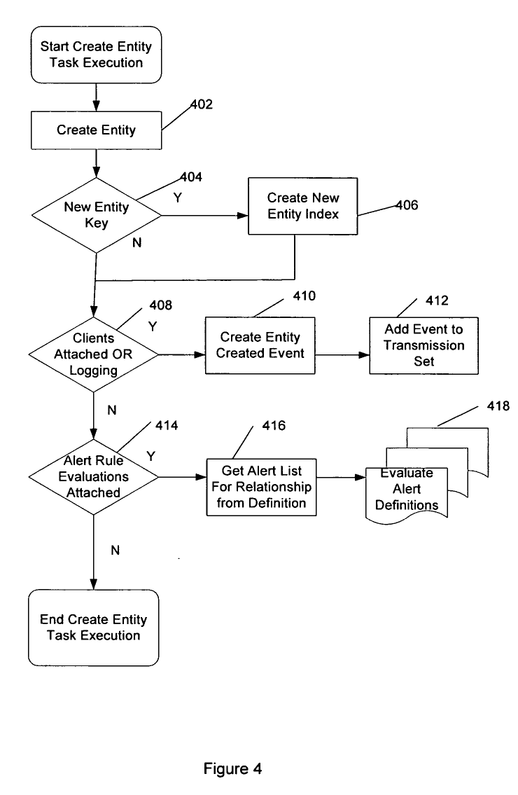

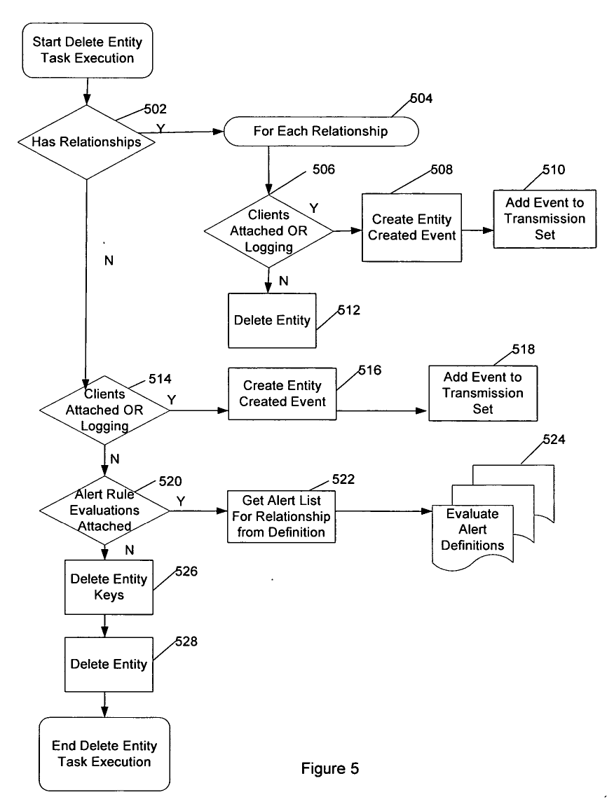

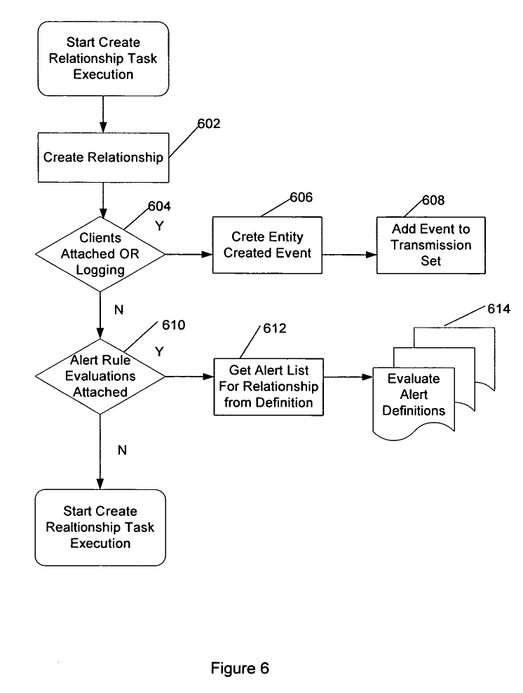

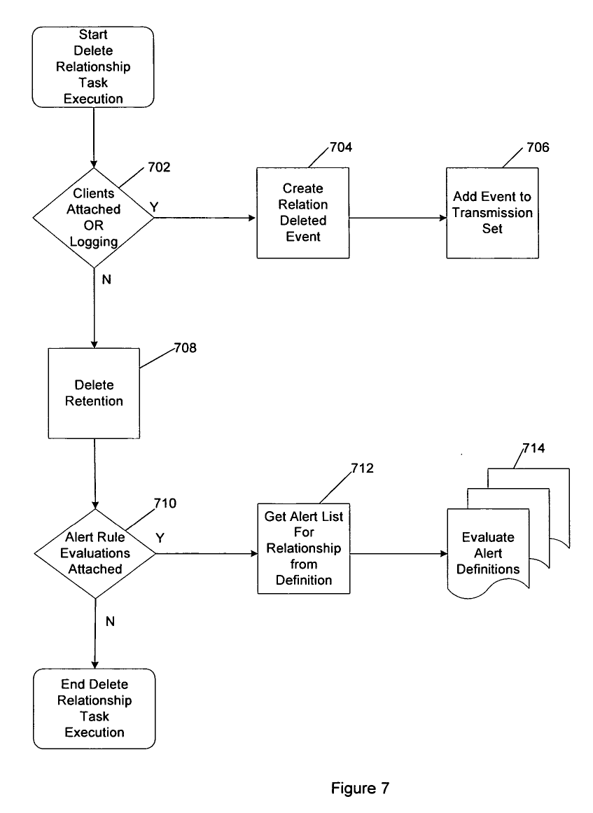

These tasks may:
Create an abstract entity (see FIG. 4)
Delete an abstract entity (see FIG. 5)
Create a relationship (see FIG. 6)
Delete a relationship (see FIG. 7)
Execute a java-like code procedure
Install triggers
Remove triggers.

If clients are attached 314, the agent sends 316 a transmission set. If a client is logging 318, the agent adds 320 the transmission set to the log.

Creating an Entity

In this embodiment of the present invention, an Abstract Entity has:
A set of keys which define mappings from items of program level data to the Entity
Possible explicitly specified relationships
Publicly available Properties which are selected views onto program level information, either directly or historically
Internal member data
Commands which may alter the underlying program.

A flow diagram for Entity creation tasks is provided in FIG. 4.

A task creates 402 an Entity and may initialize relationships, properties and members. These may be initialised using any data in the executing program available at the point of the trigger may be accessed via Kj expressions including:
Arguments
Stack data
Member data
Objects.

If the agent is logging events or is sending events to a client program 408 an event will be automatically generated 410 when an Entity is created and added 412 to the event transmission set.

If alert rule evaluations are attached 414, the agent gets 416 the alert list for the relationship from the definition and evaluates 418 the alert definitions.

Deleting an Entity

A flow diagram for Entity deletion is shown in FIG. 5.

When an Entity is deleted all data associated with it is freed and all relationships in which it participates are deleted. If it has relationships 502, for each relationship 504 if clients are attached or logging 506, then the agent creates 508 an EntityAttached event that is added 510 to the transmission set, else the entity is deleted 512.

If the agent is logging events or is sending events to a client program 514 an event will be automatically generated 516 when an Entity is deleted and added 518 to the event transmission set.

If alert rule evaluations are attached 520, the agent gets the alert list for the relationship 522 from the definition and evaluates the alert definitions 524.

If no clients are attached or logging and alert rule evaluations are not attached, the agent deletes the entity keys 526 and deletes the entity 528.

Creating a Relationship

A flow diagram for Relationship creation is shown in FIG. 6.

In this embodiment of the present invention a Relationship:
May be between two or more Entities
Each Entity in the relationship has a named role
Relationships may also have properties.

A task creates a Relationship 602. If the agent is logging events or is sending events to a client program 604 an event will be automatically generated 606 when a Relationship is created and added 608 to the event transmission set.

If alert rule evaluations are attached 610, the agent gets the alert list for the relationship 612 from the definition and evaluates the alert definitions 614.

Deleting a Relationship

A flow diagram for Relationship deletion is shown in FIG. 7.

If the agent is logging events or is sending events to a client program 702 an event will be automatically generated 704 when a Relationship is deleted and added to the event transmission set 706.

If no clients are attached or logging and alert rule evaluations are not attached, the agent deletes the Relationship 708.

If alert rule evaluations are attached 710, the agent gets the alert list for the relationship 712 from the definition and evaluates the alert definitions 714.

Executing Alert Rules

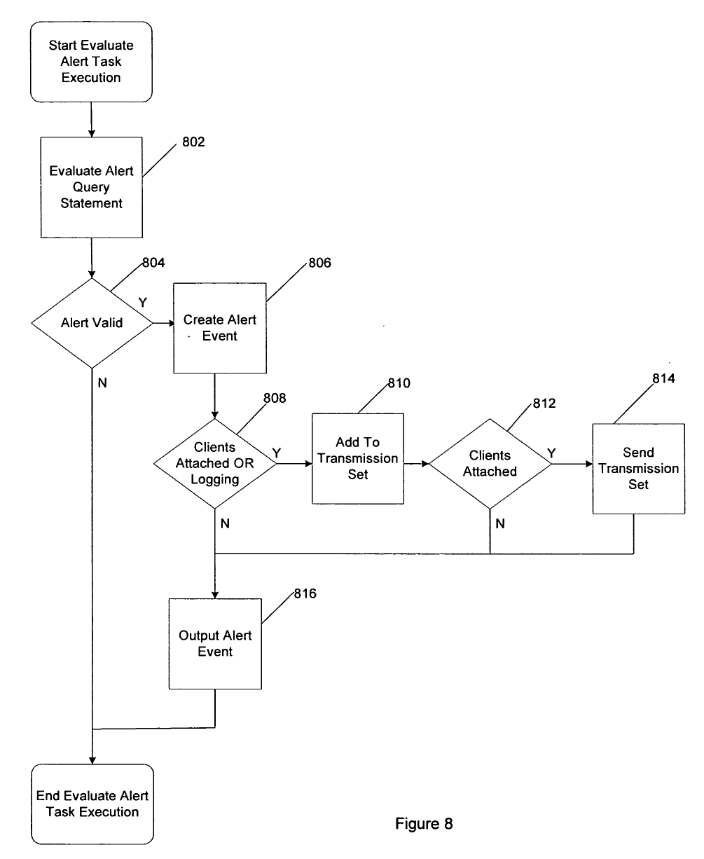

With reference to FIG. 8, as entities are created or destroyed and relationships formed or deleted, checks on the current structure of the model are executed. Each check is executed only when relevant model changes are made.

If a check 802 proves positive 804 then the set of elements involved in the antipattern structure are packed into an Alert object 806, added to the transmission set 810 and if any clients are attached 812, sent to the attached clients 814. The alert is always logged. The alert event is output 816.

When a client receives an Alert it may stop execution allowing the state of the server to be further explored.

Visualizing the Conceptual Model

An important aspect of the invention is that the Entity Relationship Attribute model of the framework provides a natural basis for the operation of the framework to be visualized, with graphical analogues shown for each Entity and Relationship and these annotated with selected details of their Attributes. Each event which deletes or creates a model entity or relationship can be directly represented by equivalent changes in the visualization analogue.

At any point in the execution of the server an attached visualization client may query the model to retrieve selected Entities, Relationships, and Attributes. These are displayed.

This embodiment of the present invention uses a nested grid layout: Some entities are displayed contained within other entities and the top level entities are laid out on a grid according to pre-assigned coordinates based on the name of the entity.

As the conceptual model changes, events defining:
Entity creation
Entity Deletion
Relation Creation
Relationship Deletion
Attribute Changes
Anti-Pattern Alerts
   are sent to linked clients. These may then trace out the event and make corresponding changes to the server visualization

Even at the conceptual level the number of Enties and Relationships representing an application server is too large to be easily represented on a normal computer screen. The invention employs a graphical, zoomable representation of these abstract entities to enable the full picture to be seen and explored.

This can be seen to be similar to design software that displays design-time representations of program parts. However here the items are at a higher conceptual level and represent actual parts of an executing application server. They are updated in real-time.

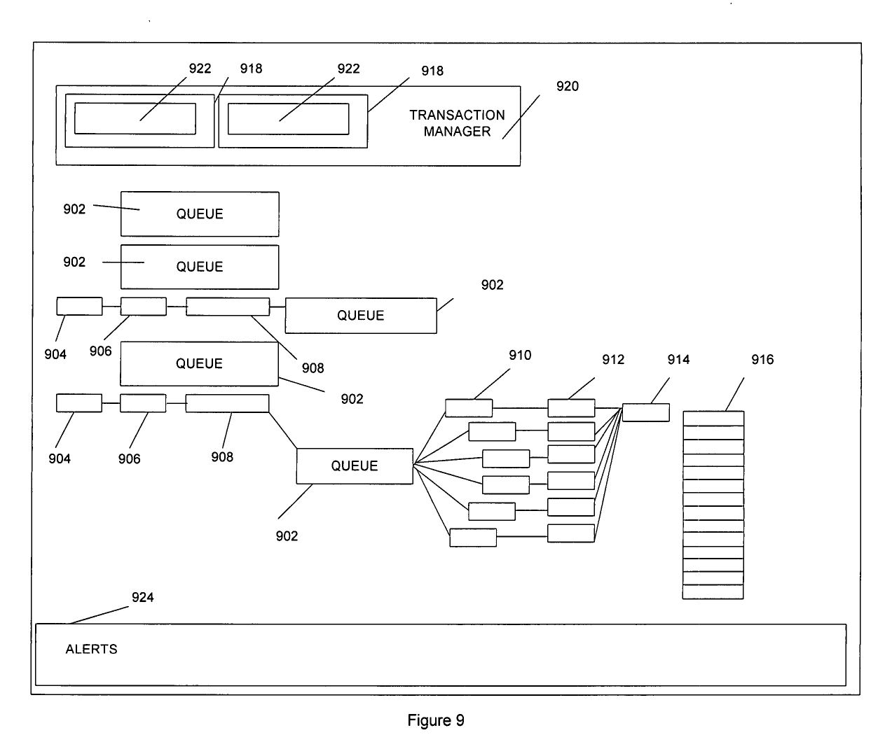

A sample screen shot of the display of an implementation of the invention is shown in FIG. 9. It shows:
five JMS Queues 902, two with attached JMS Connections 904, Sessions 906 and a JMS Sender 908;
one Queue has attached JMS Receivers 910, Sessions 912 and a Connection 914 for a Message-Driven Bean 916;
at the top of the screen a representation of in-flight transactions 918 in the Transaction Manager 920, and their associated resources 922; and
alerts 924 with their explanations.

Further modifications and improvements may be added without departing from the scope of the invention herein described.

1. A system for monitoring a computer program and maintaining an abstracted model of the computer program, the system comprising an agent adapted to set a plurality of execution points in the program, to monitor the execution points during the running of the computer program and upon execution of the computer program at at least one of the execution points, to update the abstracted model of the computer program.

2. A system as claimed in claim 1 wherein, the agent is further adapted to detect a pattern in the abstracted model and issue an alert upon detection of the pattern.

3. A system as claimed in claim 1 wherein, the agent is adapted to detect the pattern upon update of the abstracted model.

4. A system as claimed in claim 1 wherein, the system further comprises a model definition module adapted to store the definition of the abstracted model of the computer program and the agent is further adapted to update the abstracted model using the stored definition.

5. A system as claimed in claim 1 wherein, the system further comprises a client module adapted to cause the display of the abstracted model.

6. A system as claimed in claim 1 wherein, the system further comprises a program-level model and the agent is further adapted to update the program-level model upon execution of the computer program at the at least one of the execution points.

7. A system as claimed in claim 6 wherein, the program-level model comprises a static component containing class and method level information and a dynamic component containing method call and object level information, the agent being further adapted to update the dynamic component of the program-level model upon execution of the computer program at the at least one of the execution points.

8. A system as claimed in claim 1 wherein, the abstracted model is adapted to store one or more entities representing individual program objects or selected parts of several program objects or the presence of any one of several program objects or part of a program object and to store relationships between the entities.

9. A system as claimed in claim 8 wherein each of said one or more entities corresponds to an individual program object or selected parts of several program objects or the presence of any one of several program objects or a part of a program object.

10. A method for monitoring a computer program, the method comprising the steps of:
setting a plurality of execution points in the program;
creating an abstracted model of the program;
monitoring the execution points during running of the program; and
upon execution of the program at at least one of the execution points updating the abstracted model of the program.

11. A method as claimed in claim 10, further comprising the steps of detecting a pattern in the abstracted model and issuing an alert upon detection of a pattern.

12. A method as claimed in claim 11 wherein, the step of detecting the pattern is performed upon update of the abstracted model.

13. A method as claimed in claim 10 further comprising the step of storing the definition of an abstracted model of the program and the step of updating the abstracted model is dependent on the stored definition.

14. A method as claimed in claim 10 further comprising, the step of displaying the abstracted model.

15. A method as claimed in claim 10 further comprising the step of updating the abstracted model comprises storing or destroying one or more entities and relationships between the entities.

16. A method as claimed in claim 15 wherein each of the one or more entities corresponds to an individual program object or selected parts of several program objects or the presence of any one of several program objects or a part of a program object.

17. A computer program comprising program instructions for causing a computer to perform the method according to claim 10.

18. A computer program as claimed in claim 17 wherein said second computer program is embodied on a recording medium or read-only memory, stored in at least one computer memory, or carried on an electrical carrier signal.
